(19) United States
(12) Patent Application Publication
(10) Pub. No.: US 2008/0251529 A1
(43) Pub. Date: Oct. 16, 2008

(54) Storage System For Transfer Stabilizing Supports and/or Containers

(75) Inventors: Philip Sheets, York, PA (US); Paul Kelley, Wrightsville, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: Graham Packaging Company L.P., York, PA (US)

(21) Appl. No.: 10/594,845

(22) PCT Filed: Mar. 24, 2005
(86) PCT No.: PCT/US2005/009940

§ 371 Date: Jun. 25, 2008

(51) Int. Cl. B65D 83/00; G07F 11/00

(52) U.S. Cl. 221/75; 221/1

(57) ABSTRACT

A method and system for storing and releasing objects onto a production line are disclosed. The system includes an enclosed space with an opening at a side surface adjacent a top thereof, a central structure of the enclosed space, a helical support disposed about the central structure providing layers of storage to store objects to be released onto a production line, and pusher means for moving stored objects around the central structure from the bottom of the enclosed space by pushing a number of stored objects to the top of the enclosed space and out the opening. The objects may be transfer stabilizing supports that are attached to odd-shaped objects for case of conveyance, containers, or containers attached to transfer stabilizing supports.

### BACKGROUND OF THE INVENTION

1. Field of the Invention

The present invention relates generally to a method and system for storing objects prior to release in a packaging operation and for releasing objects in the appropriate orientation, and more particularly to a storage device for holding transfer stabilizing supports and/or containers and then releasing the same onto a packaging conveyor system in the appropriate orientation.

2. Related Art

Known systems for storing and releasing transfer stabilizing supports onto a packaging conveyor belt employ manual labor that picks up individual transfer stabilizing supports and/or containers and places them in the proper orientation. Alternatively, a number of transfer stabilizing supports and/or containers may be dumped onto the conveyor belt and then reoriented, for example by being bulk “descrambled”, in the proper upright orientation.

In addition to the high cost of manual labor, known systems suffer from an inability to feed a large number of transfer stabilizing supports and/or containers at one time. One disadvantage is that there is a need to orient or “descramble” bulk deposited or manually deposited transfer stabilizing and/or containers. This step of proper orientation requires more time, and slows down the packaging procedure.

With conventional systems for storing and releasing transfer stabilizing supports onto a packaging conveyor belt, a large amount of space is needed to either have a group of workers pick-up and orient transfer stabilizing supports, or a large amount of area is need so that bulk deposited transfer stabilizing supports can be placed in the proper orientation prior to being released onto the packaging system. Thus, a large staging area is necessary in known systems for storing and releasing transfer stabilizing supports onto a packaging conveyor system.

What is needed then is, a storage system for transfer stabilizing supports and/or containers that overcomes shortcomings of conventional solutions.

### BRIEF SUMMARY OF THE INVENTION

In summary, the storage system according to the invention provides a compact storage system that mechanically feeds objects, such as transfer stabilizing supports and/or containers, in an appropriate orientation to a packaging operation. As a result of the claimed system and storage device, a plurality of objects, such as transfer stabilizing supports and/or containers, may be stored in a space and then released to a packaging operation in an area smaller than previously thought possible and then fed to a packaging operation without the need to reorient the supports and/or containers and without the need of costly man power. The storage device may be filled with containers and/or supports with another mechanical operation, such as reversing the conveyor and feeding containers and/or supports to fill the storage device.

In that known packaging operations employ a manual orientation procedure, it is believed that this invention solves a previously unrecognized problem.

This invention provides advantages that were not previously appreciated. Again, known production lines employed manpower or large sorting machines to orient containers when the containers initially approach the packaging production line and to Applicants' knowledge no one considered the space reduction and savings in man power achieved by the storage system according to the invention.

The claimed invention achieves the above advantages and more with a system for storing and releasing objects, such as transfer stabilizing supports, containers or transfer stabilizing supports attached to containers, where the system comprises an enclosed space with an opening at a side surface adjacent a top thereof; a center structure indicating the center of the enclosed space; a helical support disposed about the center structure providing layers of storage to store objects, such as transfer stabilizing supports, containers or transfer stabilizing supports attached to containers; and a pusher blade movably disposed around the center structure so that the pusher blade moves from the bottom of the enclosed space in order to push a line of the stored objects, such as transfer stabilizing supports, containers or transfer stabilizing supports attached to containers, to the top of the enclosed space and out the opening.

Further objectives and advantages, as well as the structure and function of preferred embodiments will become apparent from a consideration of the description, drawings, and examples. While the invention is described with respect to an exemplary embodiment that stores transfer stabilizing supports, any object that needs to be released onto a production line with the appropriate orientation may be employed with the method and system according to the invention.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts a perspective view of an exemplary embodiment of a storage and release device according to the present invention;

FIG. 2 depicts a cross section of the storage and release device according to FIG. 1;

FIG. 3 depicts a top view of the storage and release device along line III-III showing stored transfer stabilizing supports according to the present invention;

FIG. 4 depicts an exemplary embodiment of a cross section of the storage and release device according to the present invention; and

FIG. 5 depicts another exemplary embodiment of a cross section of the storage and release device according to the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

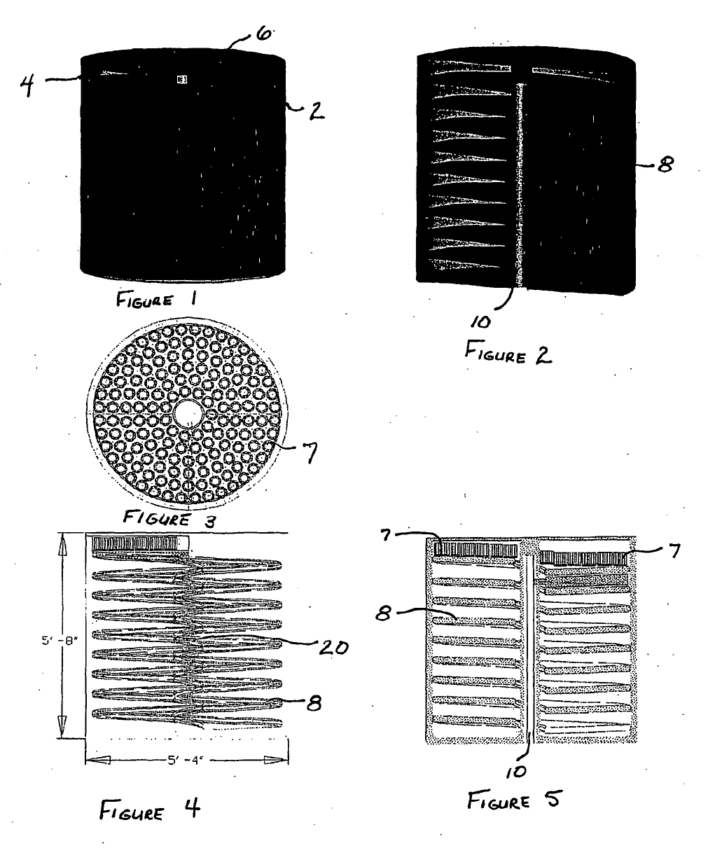

Looking at FIG. 1, one embodiment of a storage and release device according to the invention is shown. In the illustrated embodiment, a cylindrical enclosure 2 has an opening 4 at a side surface adjacent a top 6 thereof. Opening 4 is of a height that allows a line of transfer stabilizing supports (7), which are employed to stabilize and/or support an odd-shaped container or object to be conveyed in a production line, to be pushed out of enclosure 2 and onto a packaging conveying operation. Alternatively, the stored objects may be containers, or containers attached to transfer stabilizing supports and opening 4 is designed with a height and width to accommodate a line of containers or a line of containers attached to supports. While a cylindrical enclosure is shown as the exemplary embodiment, the cross-section of the enclosure could be any shape as long as the helical support has side walls so that the stored objects, such as supports and/or containers cannot be trapped within the enclosure.

A helical support 8 winds around a center rod 10 inside cylindrical enclosure 2. Helical support 8 rises from the bottom of cylindrical enclosure 2 with a helical support surface that spans from the inside of cylindrical enclosure 2 to a few inches shy of center rod 10 where the top surface of helical support 8 ends adjacent opening 4. As a result of this structure, a number of transfer stabilizing supports (7) and/or containers can be stored within a cylindrical enclosure 2, as shown in FIG. 3.

In order to push the stored transfer stabilizing supports and/or containers up from the bottom of the helical support 8 to the opening 4, a pusher blade 12 (see FIG. 5) moveably disposed around center rod 10 is employed so that pusher blade 12 can sweep across the surface of helical support 8 pushing transfer stabilizing supports and/or containers stored on the helical support surface from the bottom of cylindrical enclosure 2 up the helical support 8 to opening 4. While FIG. 5 shows a pusher blade with a relatively straight blade, the pusher blade may have a curved or sinusoidal shape or a shape depending upon the objects to be pushed. If a number of stored supports and/or containers are disposed on the helical support surface of the helical blade 8, the sweeping motion of pusher blade 12 up helical support 8 moves stored supports and/or containers in front of pusher blade 12, which in turn push stored supports and/or containers in front of the blade pushed supports and/or containers so that a line of supports and/or containers at the top of the cylindrical enclosure 2 is pushed out onto the packaging conveying area in the appropriate orientation. Pusher blade 12 may be moveably attached to center rod 10 via a concentric hollow rod that surrounds center rod 10 and has a helical groove to which an end 14 of pusher blade 12 is attached. Depending upon the desired mechanical force and control, a spring-loaded system, a motor driven system or other drive system know to those skilled in the art may provide the necessary rotation of pusher blade 12.

As an example, a spring-loaded system once activated would turn the longitudinal force of the spring into a rotary force due to the helical groove thereby causing pusher blade 12 to sweep up the ramp of helical support 8. As shown in FIG. 4, instead of cylindrical center rod 10, a center helical dual rail 20 may be employed. In this embodiment of the invention, the end 14 of pusher blade 12 would rest between the dual rail, and as the pusher blade 12 is rotated, the pusher blade 12 would follow the helical dual rail 20 thereby causing the pusher blade 12 to sweep up the ramp of helical support 8.

The dimensions of the cylindrical enclosure 2 depend upon the size of the transfer stabilizing supports and/or the size of the containers to be stored, if containers are going to be stored with the supports, or by themselves. FIG. 4 indicates that the Applicants' envision the width of the enclosure to be approximately 5 feet, 4 inches and the height to be about 5 feet, 8 inches. Of course, the size of the enclosure would depend upon the dimension of the supports and/or containers to be stored, as well as the amount of the supports and/or containers to be stored. Each layer or surface of the helical support 8 within the turns of the helix would be able to store a number of supports and/or containers to be stored. Since Applicants' envision about six supports and/or containers to be stored to be pushed out at the top of the cylindrical enclosure 2, with no need to descramble or orient, a less costly and more efficient packaging operation would result.

In addition, the enclosed storage system would enable a packaging operation to quickly convert from one type or size of container to another simply by changing the enclosed storage system according to the invention. That is, a cylindrical enclosure 2 would be positioned in an area before the actual packaging operation and would push out a line of supports and/or containers onto the packaging area in the upright position. The pushed-out stored containers would then be moved and funneled down to the actual packaging area where the packaging process would begin. If another container size or type is to be packaged, one would only have to deactivate pusher blade 12 thereby stopping the pushing-out of stored supports and/or containers, change the enclosure 2, which would contain supports and/or containers of the new packaging line and then, activate the pusher blade of the new enclosure 2.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A system for storing and releasing objects onto a production line, said system comprising:
an enclosed space with an opening at a side surface adjacent a top thereof;
a central structure of the enclosed space;
a helical support disposed about the central structure providing layers of storage to store objects to be released onto a production line; and
a pusher blade movably disposed around the central structure so that the pusher blade moves from the bottom of the enclosed space pushing a line of objects to the top of the enclosed space and out the opening.

2. The system according to claim 1, wherein the central structure is a center rod.

3. The system according to claim 1, wherein the central structure is a helical rail.

4. The system according to claim 3, wherein the central structure is a dual rail.

5. The system according to claim 1, further comprising a drive system to move said pusher blade up said helical support, the drive system having an pneumatic, electric, hydraulic or mechanical operation.

6. The system according to claim 5, wherein the drive system includes a spring-loaded system to move said pusher blade up said helical support.

7. The system according to claim 5, wherein the drive system is a motor-driven system to move said pusher blade up said helical support.

8. The system according to claim 1, wherein the objects are selected from the group consisting of transfer stabilizing supports, containers and transfer stabilizing supports with containers.

9. The system according to claim 1, wherein the objects are transfer stabilizing supports that support an odd-shaped container or object to be conveyed in a production line.

10. The system according to claim 1, wherein the objects are containers.

11. The system according to claim 1, wherein the objects are transfer stabilizing supports attached to containers.

12. A system for storing and releasing objects onto a production line, said system comprising:
an enclosed space with an opening at a side surface adjacent a top thereof;
a central structure of the enclosed space;
a helical support disposed about the central structure providing layers of storage to store objects to be released onto a production line; and
pusher means for moving stored objects around the central structure from the bottom of the enclosed space by pushing a number of objects to the top of the enclosed space and out the opening.

13. The system according to claim 12, wherein the central structure is a center rod.

14. The system according to claim 12, wherein the central structure is a helical rail.

15. The system according to claim 14, wherein the central structure is a dual rail.

16. The system according to claim 12, wherein said pusher means comprises a drive system to move said pusher means in a controlled manner up said helical support.

17. The system according to claim 16, wherein the drive system includes a spring-loaded system to move said pusher means up said helical support.

18. The system according to claim 16, wherein the drive system is a motor-driven system to move said pusher means up said helical support.

19. A method for providing an object to a production line, comprising the steps of:
positioning an enclosure filled with objects to be conveyed in a packaging production line in an area before the actual packaging operation;
activating means to push a number of stored objects out of the enclosure and onto the packaging production line area with an appropriate orientation; and
moving the pushed-out stored objects toward the actual packaging operation.

20. The method according to claim 19, further comprising the step of deactivating the means for pushing stored objects, if another size or type object is to be packaged; and then, replacing the initial enclosure with a new enclosure containing stored objects of the desired size and/or type, and activating the pusher means within the new enclosure.
